(19) United States
(12) Patent Application Publication
(10) Pub. No.: US 2026/0269387 A1
(43) Pub. Date: Sep. 10, 2026

(54) SURFACE CONTACT BATTERY

(71) Applicant: Shenzhen Oriental Willing New Energy Co., Ltd, Shenzhen (CN)

(72) Inventor: KUNLI WANG, Zunyi (CN)

(21) Appl. No.: 19/660,554

(22) Filed: Apr. 28, 2026

(30) Foreign Application Priority Data
Apr. 20, 2026 (CN) 202610520245.X

(51) Int. Cl. H01M 50/179; H01M 10/052; H01M 50/107; H01M 50/124; H01M 50/287; H01M 50/593

(52) U.S. Cl. CPC H01M 50/179; H01M 10/052; H01M 50/107; H01M 50/1245; H01M 50/287; H01M 50/593; H01M 2200/105

(57) ABSTRACT

Provided is a surface contact battery, which includes lithium battery cells. Each lithium battery cell has an initial positive electrode and an initial negative electrode. A bracket is provided at an end of the initial positive electrode of the lithium battery cell. The bracket is provided with a first avoidance hole and a side avoidance hole. A top PCB board is provided on the bracket. A conductive protective cover is provided. The conductive protective cover has an accommodation cavity for accommodating the lithium battery cells, the bracket, and the top PCB board. A plug-in positive electrode is electrically connected to the top PCB board and protrudes towards a top. A plug-in negative electrode is electrically connected to the top PCB board and protrudes towards the top. An outer membrane is made of insulating material and wraps the conductive protective cover.

### CROSS-REFERENCE TO RELATED APPLICATIONS

This application claims priority to Chinese Patent Application No. 202610520245.X, filed on Apr. 20, 2026, which is hereby incorporated by reference in its entirety.

### TECHNICAL FIELD

The present disclosure relates to the field of battery technologies, and in particular, to a surface contact battery.

### BACKGROUND

In traditional battery conduction mode, the positive electrode contacts the shrapnel, and the negative electrode contacts the spring. This structure has a small contact area and a contact resistance of approximately 5 m Ω. Point contact is prone to produce electric arcs. Long-term use easily leads to oxidation, resulting in an increase in internal resistance. Moreover, due to hard contact and compression, repeated wear of the shrapnel and spring further raises the internal resistance. This simultaneously causes wear to the gold plating on the positive terminal cap and the nickel plating on the negative terminal of the battery, which also contributes to higher internal resistance. In severe cases, the negative terminal may partially break, leading to battery leakage and posing a safety hazard. The increase in internal resistance caused by various factors gradually reduces the supply current, thereby shortening the battery's lifespan.

### SUMMARY

Given the above situation, it is necessary to propose a surface contact battery with low internal resistance.

In order to solve the above technical problems, the present disclosure adopts a technical solution for a surface contact battery, including:
a lithium battery cell, with an initial positive electrode and an initial negative electrode;
a bracket, provided at an end where the initial positive electrode of the lithium battery cell is located, and provided with a first avoidance hole for exposing or protruding the initial positive electrode and a side avoidance hole connected to the initial negative electrode;
a top PCB board, which is provided on the bracket, a positive pin of the top PCB board is electrically connected to the initial positive electrode through the first avoidance hole, and a negative pin is connected to the initial negative electrode through the side avoidance hole and the electrical connection strip;
a conductive protective cover, provided with an accommodation cavity for accommodating the lithium battery cells, the bracket, and the top PCB board;
a plug-in positive electrode, electrically connected to the top PCB board and protruding towards a top;
a plug-in negative electrode, which is electrically connected to the top PCB board and protrudes towards the top; one of the plug-in positive electrode and the plug-in negative electrode is cylindrical and surrounds the other, and the surrounded plug-in positive electrode/plug-in negative electrode is cylindrical or cylinder-shape protruding; and
an outer membrane, made of insulating material and wrapping the conductive protective cover, and the plug-in positive electrode and plug-in negative electrode protruding outside the conductive protective cover and the outer membrane.

In some embodiments of the present disclosure, the surface contact battery further includes a bottom PCB board and an insulation base pad; the insulation base pad is attached to a bottom of the lithium battery cell, and the bottom PCB board is provided on one side of the insulation base pad facing away from the lithium battery cell; the insulation base pad is provided with a second avoidance hole, and the bottom PCB board is electrically connected to the initial negative electrode of the lithium battery cell through the second avoidance hole and the negative electrode strip; one end of the conductive protective cover is electrically connected to a positive electrode pin of the bottom PCB board, and the other end is electrically connected to a positive electrode pin of the top PCB board.

In some embodiments of the present disclosure, the conductive protective cover and the outer membrane have a third avoidance hole; a bottom surface of the bottom PCB board is provided with a positive electrode surface and a negative electrode surface exposed from the third avoidance hole, and there is an insulation or a safety gap between the positive electrode surface and the negative electrode surface.

In some embodiments of the present disclosure, the surface contact battery further includes an NTC contact ring, and the NTC contact ring is electrically connected to the top PCB board and surrounds the plug-in positive electrode at intervals; the NTC contact ring protrudes towards the top.

In some embodiments of the present disclosure, the plug-in positive electrode is a positive electrode cap, and the positive electrode cap is welded onto the top PCB board; the initial positive electrode and the top PCB board are electrically connected through a conductive component that is provided in the first avoidance hole.

In some embodiments of the present disclosure, the conductive protective cover includes a cylinder wall, one end of the cylinder wall is provided with a support ring and the other end is provided with a plurality of bending feet; the support ring supports the insulation base pad, and the bending feet bend inward to block the top PCB board.

In some embodiments of the present disclosure, the outer membrane includes a top ring, a cylindrical membrane, and a bottom ring that are connected in one piece; the bottom ring covers the support ring, and the top ring wraps around the bending feet.

In some embodiments of the present disclosure, the bracket is provided with an accommodation slot and a plurality of component avoidance holes, the accommodation slot and the plurality of component avoidance holes accommodate components on the top PCB board and form an end face of an arc wall of the accommodation slot to support a board body of the top PCB board.

In some embodiments of the present disclosure, a plurality of positioning columns are provided on the bracket, and the top PCB board has positioning holes on a board body that are compatible with the positioning columns.

The beneficial effect of the present disclosure is that both the positive and negative electrodes of the battery can be connected by plug-in connection from a front end. A positive output of a charging battery passes through the initial positive electrode, the top PCB board, and the plug-in positive electrode in sequence. A negative output of the front end passes through the initial negative electrode, the electrical connection strip, the top PCB board, and the plug-in negative electrode in sequence. A front output of the battery becomes a plug-in surface contact, zero distance contact, and an internal resistance is reduced to about 0.5 m Ω, which is nearly 10 times lower than the internal resistance of the traditional spring connection method. It also reduces the generation of electric arcs and extends the service life of the battery.

### BRIEF DESCRIPTION OF DRAWINGS

FIG. 1 is a structural schematic diagram of a surface contact battery provided by the present disclosure in an embodiment.

FIG. 2 is a structural schematic diagram of the surface contact battery in another direction provided by the present disclosure in an embodiment.

FIG. 3 is a partial sectional structure schematic diagram of the surface contact battery provided by the present disclosure in an embodiment.

FIG. 4 is a decomposed structural schematic diagram of the surface contact battery provided by the present disclosure in an embodiment.

FIG. 5 is a structural schematic diagram of a surface contact battery provided by the present disclosure in in another embodiment.

FIG. 6 is a decomposed structural schematic diagram of the surface contact battery provided by the present disclosure in another embodiment.

FIG. 7 is a sectional structure schematic diagram of a surface contact battery provided by the present disclosure in still one embodiment.

FIG. 8 is a structural schematic diagram of the surface contact battery provided by the present disclosure in in still one embodiment.

FIG. 9 is a decomposed structural schematic diagram of the surface contact battery provided by the present disclosure in still one embodiment.

FIG. 10 is a decomposed structural schematic diagram of the surface contact battery in another direction provided by the present disclosure in still one embodiment.

FIG. 11 is a structural schematic diagram of a bracket of the surface contact battery in a bottom direction provided by the present disclosure in in still one embodiment.

FIG. 12 is a connection structural schematic diagram of an electrical connection strip of the surface contact battery provided by the present disclosure in in an embodiment.

Numeral reference: 100—lithium battery cells; 110—initial positive electrode; 120—initial negative electrode; 200—insulation base pad; 210—second avoidance hole; 310—bottom PCB board; 311—positive electrode surface; 312—negative electrode surface; 320—top PCB board; 321—positioning hole; 322—MOS transistor; 400—bracket; 410—first avoidance hole; 420—accommodation slot; 430—component avoidance hole; 440—positioning column; 450—side avoidance hole; 500—conductive protective cover; 510—cylinder wall; 520—support ring; 530—bending foot; 610—plug-in positive electrode; 611—conductive component; 620—NTC contact ring; 630—plug-in negative electrode; 700—outer membrane; 710—top ring; 720—cylinder membrane; 730—bottom ring; 731—third avoidance hole; 800—electrical connection strip; 810—negative electrode strip.

### DESCRIPTION OF EMBODIMENTS

In order to further clarify the purpose, technical solution, and advantages of the present disclosure, the following will provide a detailed explanation of the present disclosure in combination with the accompanying drawings and embodiments. It should be understood that specific embodiments described herein are only used to explain the present disclosure and are not intended to limit the present disclosure.

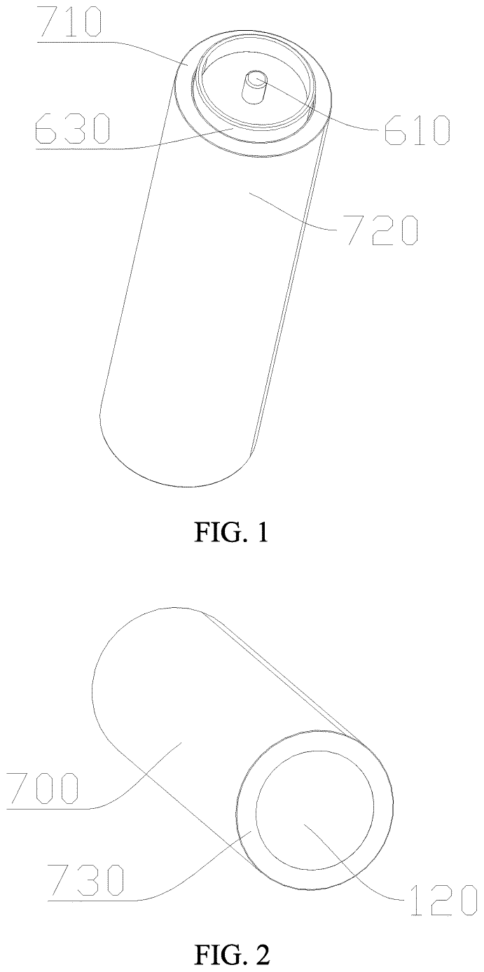

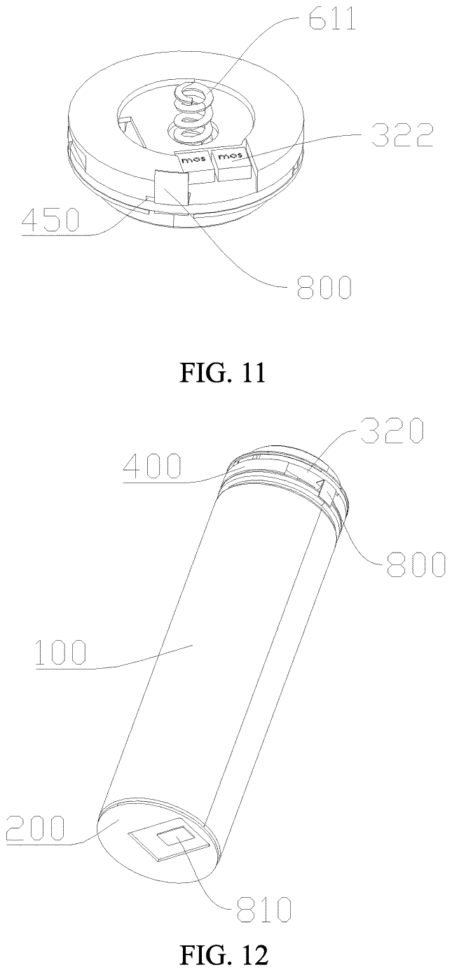

Referring to FIGS. 1-4 and FIGS. 11-12 in an embodiment, a surface contact battery includes:
a lithium battery cell 100, with an initial positive electrode 110 and an initial negative electrode 120;
a bracket 400, provided at an end where the initial positive electrode 110 of the lithium battery cell 100 is located, and provided with a first avoidance hole 410 for exposing or protruding the initial positive electrode 110 and a side avoidance hole 450 connected to the initial negative electrode 120;
a top PCB board 320, which is provided on the bracket 400, a positive pin of the top PCB board 320 is electrically connected to the initial positive electrode 110 through the first avoidance hole 410, and a negative pin is connected to the initial negative electrode 120 through the side avoidance hole 450 and the electrical connection strip 800;
a conductive protective cover 500, provided with an accommodation cavity for accommodating the lithium battery cells 100, the bracket 400, and the top PCB board 320;
a plug-in positive electrode 610, electrically connected to the top PCB board 320 and protruding towards a top;
a plug-in negative electrode 630, which is electrically connected to the top PCB board 320 and protrudes towards the top; one of the plug-in positive electrode 610 and the plug-in negative electrode 630 is cylindrical and surrounds the other, and the surrounded plug-in positive electrode 610/plug-in negative electrode 630 is cylindrical or cylinder-shape protruding; that is, if the plug-in negative electrode 630 surrounds the plug-in positive electrode 610, the plug-in negative electrode 630 is cylinder-shape protruding, and the plug-in negative electrode 630 is cylindrical or cylinder shape; it can be understood that there is a safety gap between the plug-in positive electrode 610 and the plug-in negative electrode 630; and
an outer membrane 700, made of insulating material and wrapping the conductive protective cover 500, and the plug-in positive electrode 610 and plug-in negative electrode 630 protruding outside the conductive protective cover 500 and the outer membrane 700.

Both positive and negative electrode of the battery can be connected by plug-in connection from a front end, a positive output of a rechargeable battery passes through the initial positive electrode 110, the top PCB board 320, and the plug-in positive electrode 610 in sequence; a negative output of the front end passes through the initial negative electrode 120, the electrical connection strip 800, the top PCB board 320, and the plug-in negative electrode 630 in sequence; a front output of the battery becomes a plug-in surface contact, zero distance contact, and an internal resistance is reduced to about 0.5 m Ω, which is nearly 10 times lower than the traditional spring connection method; it also reduces the generation of electric arcs and extends the service life of the battery.

Referring to FIGS. 1, 3 and 4, the plug-in positive electrode 610 is a positive electrode cap, and the positive electrode cap is inserted and welded onto the top PCB board 320. The initial positive electrode 110 and the top PCB board 320 are electrically connected through a conductive component 611 arranged in the first avoidance hole 410. It can be understood that the conductive component 611 can be made of springs/shrapnel/spring pins/conductive strips as needed, and in an implementation mode, its material is copper or copper plated with gold/silver. It can be understood that the spring encapsulated inside is different from the external spring connection. Its contact surface is stable, ensuring a stable electrical connection between the initial positive electrode 110 and the top PCB board 320.

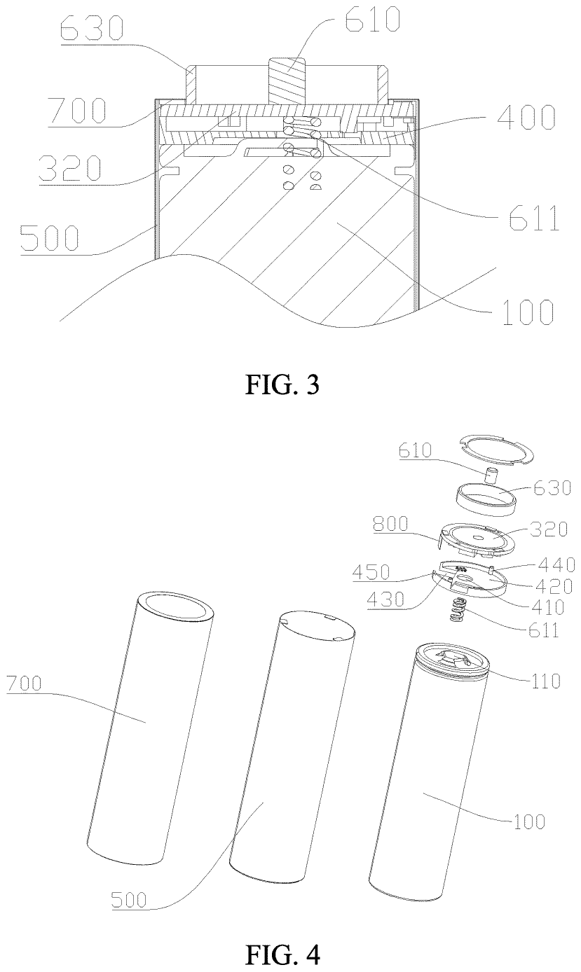

Referring to FIG. 3, 4 or 9, and 10, the conductive protective cover 500 includes a cylinder wall 510, one end of the cylinder wall 510 is provided with a support ring 520, and the other end thereof is provided with a plurality of bending feet 530. The support ring 520 supports the insulation base pad 200, and the bending feet 530 are bent inward to block the top PCB board 320. In an implementation mode, the conductive protective cover 500 is made of steel or other conductive materials. The bending feet 530 can be fastened to the top PCB board 320 by riveting.

Referring to FIG. 4 or 9, and 10, the outer membrane 700 includes a top ring 710, a cylindrical membrane 720, and a bottom ring 730 that are connected in one piece. The bottom ring 730 covers the support ring 520, and the top ring 710 wraps around the bending feet 530. The outer membrane 700 is used for packaging, protection, and insulation isolation.

Referring to FIGS. 3, 4 and 11, the bracket 400 is provided with an accommodation slot 420 and a plurality of component avoidance holes 430. The accommodation slot 420 and the component avoidance holes 430 accommodate the components on the top PCB board 320, forming an end face of an arc wall of the accommodation slot 420 to support a board body of the top PCB board 320. Providing the bracket 400 mainly facilitates the installation of the top PCB board 320 and protects the electronic components on the top PCB board 320. It can be understood that the side avoidance hole 450 and the component avoidance hole 430 can be integrated into one, that is, they are the same hole.

Referring to FIG. 4, there are also a plurality of positioning columns 440 on the bracket 400, and the top PCB board 320 has positioning holes 321 on the board body that are compatible with the positioning columns 440. A displacement of the top PCB board 320 is avoided through the positioning columns 440 and positioning holes 321.

In an implementation mode, protrusion heights of the plug-in positive electrode 610 and the plug-in negative electrode 630 are greater than or equal to 2 mm.

Generally, the initial positive electrode 110 of the lithium battery cell 100 is provided at a top, and the initial negative electrode 120 is composed of an integrated bottom and side wall. The electrical connection strip 800 can be made of conductive materials such as nickel strip and copper strip as needed. The top PCB board 320 can connect to a top of a side wall of the lithium battery cell 100 and connect to the initial negative electrode 120.

In an implementation mode, a bottom PCB board 310 and a back-end output are provided with.

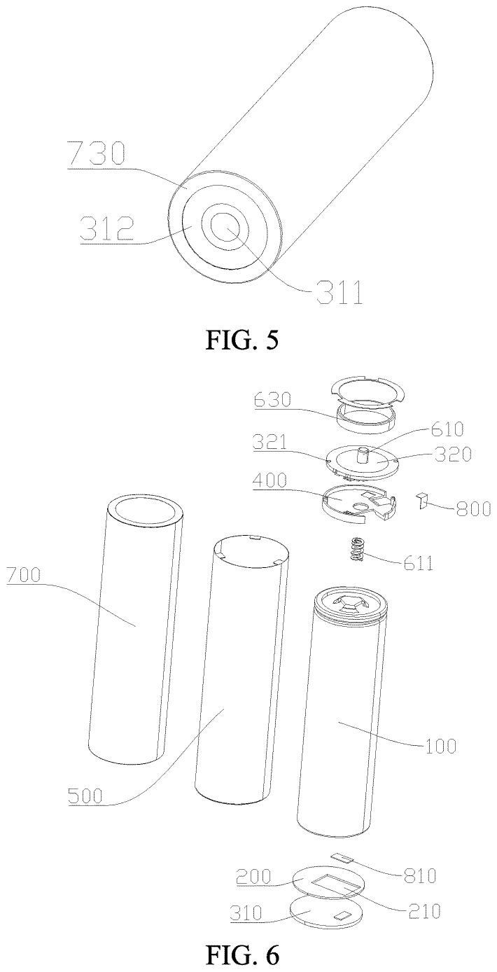

Referring to FIGS. 5 and 6, the surface contact battery further includes the bottom PCB board 310 and an insulation base pad 200. The insulation base pad 200 is attached to a bottom of the lithium battery cell 100, and the bottom PCB board 310 is provided on one side of the insulation base pad 200 facing away from the lithium battery cell 100. The insulation base pad 200 is provided with a second avoidance hole 210, and the bottom PCB board 310 is electrically connected to the initial negative electrode 120 of the lithium battery cell 100 through the second avoidance hole 210 and the negative electrode strip 810. One end of the conductive protective cover 500 is electrically connected to a positive electrode pin of the bottom PCB board 310, and the other end is electrically connected to a positive electrode pin of the top PCB board 320.

Providing two PCB boards, with one PCB board at the front and one PCB board at the back, namely the top PCB board 320 and the bottom PCB board 310, for division of labor, easy installation, and convenient PCB board heat dissipation.

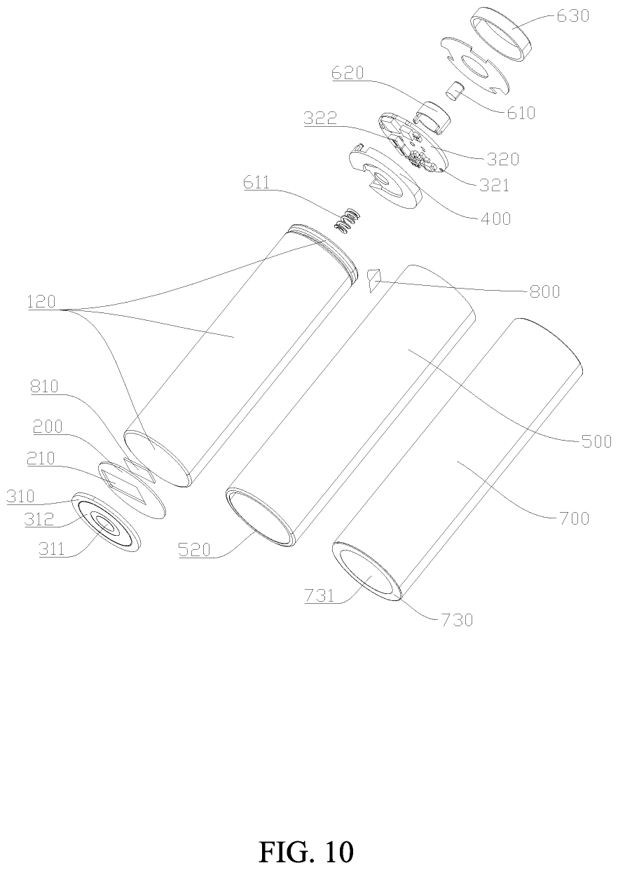

Referring to FIG. 10, the conductive protective cover 500 and the outer membrane 700 have a third avoidance hole 731. A bottom surface of the bottom PCB board 310 is provided with a positive electrode surface 311 and a negative electrode surface 312 exposed from the third avoidance hole 731, and there is an insulation or a safety gap between the positive electrode surface 311 and the negative electrode surface 312. It can be understood that one of the positive electrode surface 311 and the negative electrode surface 312 surrounds the other, with the outer one being a torus and the inner one being a torus or circular surface. Specifically, the top is positive inside and negative outside, with the plug-in positive electrode 610 provided at a center and the plug-in negative electrode 630 provided on an outer side, while the bottom is negative inside and positive outside, with the negative electrode surface 312 provided at a center and the positive electrode surface 311 provided on an outside.

Both the front and back can be electrically connected, such as the front end being used for output and the back end being used for input and charging. And due to the installation of the bottom PCB board 310, it is very convenient to set the positive electrode surface 311 and the negative electrode surface 312.

In an implementation mode, the electrical connection strip 800 and the conductive protective cover 500 can be isolated by insulation coating or insulation membrane.

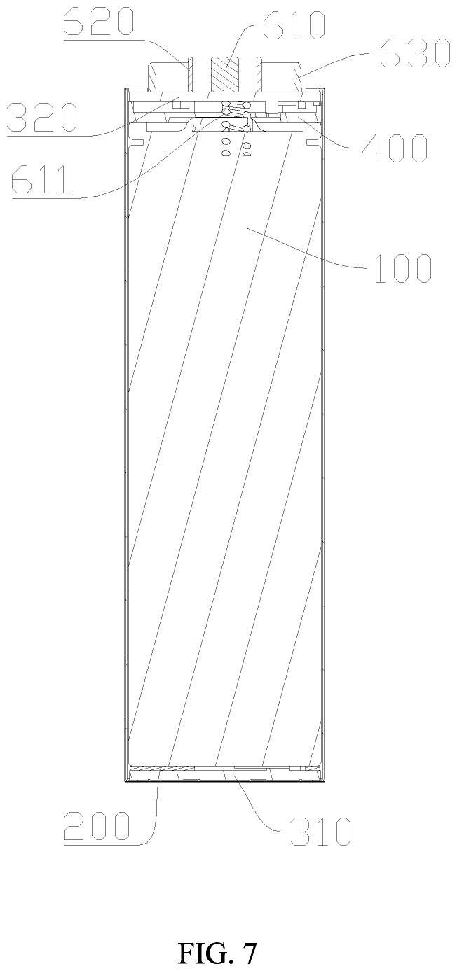

Referring to FIG. 7, the positive electrode of the top PCB board 320 and the bottom PCB board 310 are connected through a conductive protective cover 500, and the negative electrode are connected to the initial negative electrode 120. In an implementation mode, since the initial negative electrode 120 is electrically connected to the bottom PCB board 310, the electrical connection strip can be directly connected to the bottom PCB board 310 by connecting the initial negative electrode 120. Since the bottom and side walls of the lithium battery cell 100 are both the initial negative electrode 120, the electrical connection strip 800 can be directly connected to the top of the side wall (i.e. the shoulder of the side wall) and the top PCB board 320. In an implementation mode, the top PCB board 320 is provided with at least one positive pin, and the positive pin is in electrical contact with the bending feet 530 of the conductive protective cover 500. In an implementation mode, both the positive pin and the bending feet 530 are arranged in a circular array with three positive pins and three bending feet 530.

Generally, the initial negative electrode 120 can also be electrically connected to the bottom PCB board 310 through a negative electrode strip 810 (conductive strip). At this time, the negative electrode strip 810 can be folded to increase its thickness for electrical contact. Or the shrapnel can be used to connect the initial negative electrode 120 and the bottom PCB board 310 as needed. It can be understood that for ease of connection, the initial negative electrode 120 uses the bottom of the lithium battery cell 100.

In an implementation mode, the top PCB board 320 adopts Chuangxin Micro CM5+dual metal oxide semiconductor, (MOS) transistor 322, which is mainly used for charging protection, NTC temperature measurement, and equalization. The bottom PCB board 310 adopts Nanxin SC8815A main charge and discharge management, protocol docking, voltage rise and fall control, etc.

In an implementation mode, the front end has added an NTC contact ring 620.

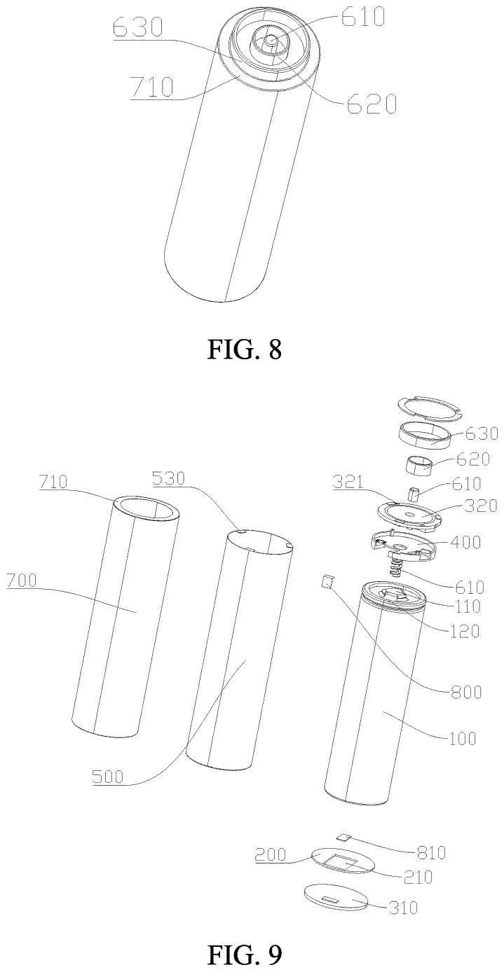

Referring to FIGS. 7-10, the surface contact battery further includes the NTC contact ring 620, and the NTC contact ring 620 is electrically connected to the top PCB board 320 and surrounds the plug-in positive electrode 610 at intervals. The NTC contact ring 620 protrudes towards the top.

It can be understood that the top PCB board 320 is integrated with an NTC module, and an NTC pin of the NTC module is electrically connected to the NTC contact ring 620.

It should be noted that if directional indications (such as up, down, left, right, front, back, etc.) are involved in the embodiments of the present disclosure, the directional indications are only used to explain the relative position relationship and motion of each component in a specific posture (as shown in the attached figure). If the specific posture changes, the directional indications will also change accordingly.

Besides that, if there are descriptions related to “first”, “second”, etc. in the embodiments of the present disclosure, the descriptions of “first”, “second”, etc. are only for descriptive purposes and cannot be understood as indicating or implying their relative importance or implying the number of technical features indicated. Therefore, the features limited to “first” and “second” can explicitly or implicitly include at least one of these features.

In summary, the present disclosure provides a surface contact battery that reduces contact internal resistance due to its technical solution. If this battery is used as the power source for a flashlight, the luminous flux can be increased by approximately 5%. Due to the single ended electrical connection of this battery, the flashlight tail cover can even be removed to reduce product costs. And the signal electrode of traditional flashlights is provided with a wire between a tail of the flashlight and an electric plate in front of the flashlight. The flashlight body serves as the negative electrode, and the positive electrode of the battery is directly connected to the circuit board in front of the flashlight, requiring dual tube bodies as a connection between the front and rear circuit boards. After adopting the battery of this application, a rear end of the battery also has positive and negative electrode, which can be directly connected to the positive and negative electrode at the bottom of the battery, that is, the positive and negative electrode faces. The connection is simple and convenient, and can be achieved with one cylinder body, with strong universality.

The above description is only a preferred embodiment of the present disclosure and is not intended to limit the present disclosure. Any modifications, equivalent substitutions, and improvements made within the spirit and principles of the present disclosure should be included within the protection scope of the present disclosure.

What is claimed is:

1. A surface contact battery, comprising:
a lithium battery cell, with an initial positive electrode and an initial negative electrode;
a bracket, provided at an end where the initial positive electrode of the lithium battery cell is located, and provided with a first avoidance hole for exposing or protruding the initial positive electrode and a side avoidance hole connected to the initial negative electrode;
a top PCB board, which is provided on the bracket, a positive pin of the top PCB board is electrically connected to the initial positive electrode through the first avoidance hole, and a negative pin is connected to the initial negative electrode through the side avoidance hole and the electrical connection strip;
a conductive protective cover, provided with an accommodation cavity for accommodating the lithium battery cells, the bracket, and the top PCB board;
a plug-in positive electrode, electrically connected to the top PCB board and protruding towards a top;
a plug-in negative electrode, which is electrically connected to the top PCB board and protrudes towards the top; one of the plug-in positive electrode and the plug-in negative electrode is cylindrical and surrounds the other, and the surrounded plug-in positive electrode/plug-in negative electrode is cylindrical or cylinder-shape protruding; and
an outer membrane, made of insulating material and wrapping the conductive protective cover, and the plug-in positive electrode and plug-in negative electrode protruding outside the conductive protective cover and the outer membrane.

2. The surface contact battery according to claim 1, further comprising a bottom PCB board and an insulation base pad; the insulation base pad is attached to a bottom of the lithium battery cell, and the bottom PCB board is provided on one side of the insulation base pad facing away from the lithium battery cell; the insulation base pad is provided with a second avoidance hole, and the bottom PCB board is electrically connected to the initial negative electrode of the lithium battery cell through the second avoidance hole and the negative electrode strip; one end of the conductive protective cover is electrically connected to a positive electrode pin of the bottom PCB board, and the other end is electrically connected to a positive electrode pin of the top PCB board.

3. The surface contact battery according to claim 2, wherein the conductive protective cover and the outer membrane have a third avoidance hole; a bottom surface of the bottom PCB board is provided with a positive electrode surface and a negative electrode surface exposed from the third avoidance hole, and there is an insulation or a safety gap between the positive electrode surface and the negative electrode surface.

4. The surface contact battery according to claim 1, further comprising an NTC contact ring, and the NTC contact ring is electrically connected to the top PCB board and surrounds the plug-in positive electrode at intervals; the NTC contact ring protrudes towards the top.

5. The surface contact battery according to claim 1, wherein the plug-in positive electrode is a positive electrode cap, and the positive electrode cap is welded onto the top PCB board;
the initial positive electrode and the top PCB board are electrically connected through a conductive component that is provided in the first avoidance hole.

6. The surface contact battery according to claim 1, wherein the conductive protective cover comprises a cylinder wall, one end of the cylinder wall is provided with a support ring and the other end is provided with a plurality of bending feet; the support ring supports the insulation base pad, and the bending feet bend inward to block the top PCB board.

7. The surface contact battery according to claim 6, wherein the outer membrane comprises a top ring, a cylindrical membrane, and a bottom ring that are connected in one piece;
the bottom ring covers the support ring, and the top ring wraps around the bending feet.

8. The surface contact battery according to claim 1, wherein the bracket is provided with an accommodation slot and a plurality of component avoidance holes, the accommodation slot and the plurality of component avoidance holes accommodate components on the top PCB board and form an end face of an arc wall of the accommodation slot to support a board body of the top PCB board.

9. The surface contact battery according to claim 1, wherein a plurality of positioning columns are provided on the bracket, and the top PCB board has positioning holes on a board body that are compatible with the positioning columns.
